(19) United States
(12) Patent Application Publication
(10) Pub. No.: US 2014/0337868 A1
(43) Pub. Date: Nov. 13, 2014

(54) AUDIENCE-AWARE ADVERTISING

(71) Applicant: Microsoft Corporation, Redmond, WA (US)

(72) Inventors: Enrique de la Garza, Sammamish, WA (US); Karin Zilberstein, Kirkland, WA (US); Alexei Pineda, Bellevue, WA (US); Andrew Flavell, Medina, WA (US); David John Wells, Renton, WA (US)

(73) Assignee: Microsoft Corporation, Redmond, WA (US)

(21) Appl. No.: 13/892,686

(22) Filed: May 13, 2013

(51) Int. Cl. H04N 21/2668; H04N 21/442

(52) U.S. Cl. CPC H04N 21/2668; H04N 21/44218
USPC 725/12

(57) ABSTRACT

Embodiments of the present invention provide an audience-aware advertising that are advertisements coordinated with both a present media presentation and the media presentation's current audience. An audience-aware advertising pod is a container for advertising content that is shown in association with a media presentation. The audience-aware advertising pod may include multiple advertisements shown during a commercial break in the primary content. The advertisements may be selected for display within a media presentation in real time based on audience members' attention level and response. Audience profiles may be generated and stored locally. The audience profile may be used to determine when an ad is displayed and what advertisement is displayed.

### BACKGROUND

Advertisements are shown before, during, and after media presentations. Advertisements are even included within media presentations through product placement. The advertisements shown with the media are selected based on anticipated audience demographics. The audience demographics may be estimated through audience studies conducted on similar media presentations.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention provide an audience-aware advertising pod that comprises advertisements that are coordinated with both a present media presentation and the media presentation's current audience. Exemplary media presentations include television, movies, games, and music. The audience includes individuals able to perceive the media presentation because of their proximity to an entertainment device generating the media presentation.

An audience-aware advertising pod is a container for advertising content that is shown in association with a media presentation. The media presentation may be described as the primary content. The audience-aware advertising pod may include multiple advertisements shown during a commercial break in the primary content. The advertisements may be selected for display within the ad pod in real time based on audience members'attention level and response. The audience-aware advertising pod may be customized on a per presentation basis.

For example, the advertising pod may be two minutes in duration and contain four 30-second advertisements. The advertisements shown within the audience-aware advertisement pod may be tailored to the specific audience watching a single instance of the media presentation. For example, a group of advertisements for video games could be shown to a young man watching an instance of the media presentation in his home and a second group of advertisements for investment firms could be shown to a middle-aged man watching the same media presentation at the same time in his apartment.

Embodiments of the present invention use audience data to select appropriate advertisements for inclusion within an ad pod. The audience data may be derived from image data generated by an imaging device, such as a video camera, that has a view of the audience area. Automated image analysis may be used to generate audience data that is used to select the overlay.

The audience data derived from the image data includes number of people present in the audience, engagement level of people in the audience, personal characteristics of those individuals, and response to the media content. Different levels of engagement may be assigned to audience members.

Audience data may be used to determine when an ad pod is displayed and what advertisements are included in the ad pod. For example, an ad pod may not be displayed when a person is present in the audience but shows a low level of attentiveness. A person's reaction to an ad in a first ad pod may be used to determine whether a second, related advertisement, is included in a second ad pod shown to the person later. For example, a person classified as having a negative reaction to a first commercial may not be shown the same commercial, or a related commercial, in a different ad pod shown later during a primary content.

Embodiments of the present invention allow advertisers to specify characteristics they want in their target viewer. The advertiser may specify characteristics of the viewer, attention levels, and viewer response. The advertiser may specify how much it is willing to pay for advertisement display to viewers meeting different criteria. The advertisers may also specify group characteristics when the audience includes multiple people.

Embodiments of the present invention may locally store a persons' consumption of and responses to media content on an entertainment device. The audience data may be stored in local user profile on an entertainment device. In one embodiment, the audience data may include a number of persons that have viewed or are actively viewing media content on the display device. Additionally, the audience data may include personal characteristics and/or identifying information about the persons. For example, the audience data may include a person's age and gender. The audience data may also include responses of persons to the displayed media content, as well as an identification of the content being displayed.

Storing the user profile locally may enhance user privacy by eliminating a need to communicate the profile data to an advertiser or ad network. The user profile may be analyzed locally to surface only generalized viewing information that is exposed to the advertiser, content provider, or others. In one embodiment, the viewing information is abstracted to a level that prevents identification of the viewer. The user profile information may be encrypted to prevent direct access by an advertiser or other party. In one embodiment, the user is invited to supply a pass code used to form the encryption key. Data in the encrypted user profile may be accessed by a program on the client that analyzes the user profile to classify the viewing record into generalized characteristics or categories of interest to an advertiser. The general characteristics or categories may be exposed to advertisers, content providers, and the like, but the actual viewing record with detailed information remains protected. The general characteristics or categories may be standardized across clients to enable use by advertisers or others that subscribe to consume locally stored information. Storing the user profile locally also conserves network data usage.

Personas are one way to abstract viewing records to protect privacy. Personas may be delivered to one or more content publishers for targeted advertising. Particularly, a persona may be communicated to a advertising exchange and exposed to advertisers. In response, targeted media content may be delivered from an advertiser to the server. The targeted media content may be directed toward a persona. The server may deliver the targeted media content to an entertainment device, and when a person assigned the persona is determined to be viewing content, the targeted media content may be presented to the person.

In one embodiment, a privacy interface is provided. The privacy interface explains how audience data is gathered and used. The audience member is given the opportunity to opt-in or opt-out of all or some uses of the audience data. For example, the audience member may authorize use of explicit audience responses, but opt-out of implicit responses.

As explained in more detail subsequently, audience data and/or viewing records may be abstracted into a persona before sharing with advertisers or otherwise complied. The use of personas maintains the privacy of individual audience members by obscuring personally identifiable information. For example, a viewing record may be recorded as a male, age 25-30, watched commercial YZ and responded positively. The actual viewer is not identified in audience data, even when some information (e.g., age) may be ascertained from a user account that includes personally identified information.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of entertainment environment, in accordance with an embodiment of the present invention;

FIG. 3 is a diagram of a remote entertainment environment, in accordance with an embodiment of the present invention;

FIG. 4 is a diagram of an exemplary audience area that illustrates presence, in accordance with an embodiment of the present invention;

FIG. 5 is a diagram of an exemplary audience area that illustrates audience member attention levels, in accordance with an embodiment of the present invention;

FIG. 6 is a diagram of an exemplary audience area that illustrates audience member response to media content, in accordance with an embodiment of the present invention;

FIG. 7 is a diagram of an a media presentation having default ads within an ad pod, in accordance with an embodiment of the present invention;

FIG. 8 is a diagram of an a media presentation having empty ad pods, in accordance with an embodiment of the present invention;

FIG. 9 is a diagram of an a media presentation having ad pods with a fixed ad and empty ad slots, in accordance with an embodiment of the present invention;

FIG. 10 is a diagram of an a media presentation having ad pods with a variable duration, in accordance with an embodiment of the present invention;

FIG. 11 is a diagram of an a media presentation having multiple insertion points for audience-aware advertising pods, in accordance with an embodiment of the present invention;

FIG. 12 is a diagram of a remote advertising environment, in accordance with an embodiment of the present invention;

FIG. 13 is a flow chart showing a method of selecting an advertisement for an inclusion in an audience-aware ad pod to be shown with an ongoing media presentation, in accordance with an embodiment of the present invention;

FIG. 14 is a flow chart showing a method of generating an audience-aware advertising pod, in accordance with an embodiment of the present invention;

FIG. 15 is a flow chart showing a method of generating an audience-aware advertising pod, in accordance with an embodiment of the present invention;

FIG. 16 is a flow chart showing a method of locally storing responses of persons to a displayed media title, in accordance with an embodiment of the present invention; and

FIG. 17 is a flow chart showing method of generating an audience profile, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide audience-aware advertisements that are coordinated with both a present media presentation and the media presentation's current audience. Exemplary media presentations include television, movies, games, and music. The audience includes individuals able to perceive the media presentation because of their proximity to an entertainment device generating the media presentation. For example, a television's audience could be those people that are able to view the television.

The audience-aware advertisements may be presented individually or as part of an audience-aware advertising pod. An audience-aware advertising pod is a container for advertising content that is shown in association with a media presentation. The media presentation may be described as the primary content. The audience-aware advertising pod may include multiple advertisements shown during a commercial break in the primary content. The advertisements may be selected for display within the ad pod in real time based on audience members' attention level and response. The audience-aware advertising pod may be customized on a per presentation basis.

For example, the advertising pod may be two minutes in duration and contain four 30-second advertisements. The advertisement shown within the audience-aware advertisement pod may be tailored to the specific audience watching a single instance of the media presentation. For example, a group of advertisements for video games could be shown to a young man watching an instance of the media presentation in his home and a second group of advertisements for investment firms could be shown to a middle-aged man watching the same media presentation at the same time in his apartment.

Embodiments of the present invention use audience data to select appropriate advertisements for inclusion within an ad pod. The advertisements may be selected from a plurality of advertisements available on an entertainment device or provided in real time from an advertising server. The audience data may be derived from image data generated by an imaging device, such as a video camera, that has a view of the audience area. Automated image analysis may be used to generate useful audience data that is used to select the advertisement. The automated image analysis may be performed on an entertainment client that generates audience data. The entertainment client may use the audience data to select advertisements for inclusion in the ad pod. In an alternative embodiment, the entertainment client may communicate audience data to an ad server that selects advertisements.

The audience data derived from the image data includes number of people present in the audience, engagement level of people in the audience, personal characteristics of those individuals, and response to the media content. Different levels of engagement may be assigned to audience members. Image data may be analyzed to determine how many people are present in the audience and characteristics of those people.

Audience data includes a level of engagement or attentiveness. A person's attentiveness may be classified into one or more categories or levels. The categories may range from not paying attention to full attention. A person who is not looking at the television and is in a conversation with somebody else, either in the room or on the phone, may be classified as not paying attention or fully distracted. On the other hand, somebody in the room who is not looking at the TV, but is not otherwise obviously distracted, may have a medium level of attentiveness. Someone that is looking directly at the television without an apparent distraction may be classified as fully attentive. A machine-learning image classifier may assign the levels of attentiveness by analyzing image data.

Audience data may include a person's reaction to the media content. The person's reaction may be measured by studying biometrics gleaned from the imaging data. For example, heartbeat and facial flushing may be detected in the image data. Similarly, pupil dilation and other facial expressions may be associated with different reactions. All of these biometric characteristics may be interpreted by a classifier to determine whether the person likes or dislikes a media content.

Audience data may be used to determine when an ad pod is displayed and what advertisements are included in the ad pod. For example, an ad pod may not be displayed when a person is present in the audience but shows a low level of attentiveness. An advertiser may specify that an ad is only shown as part of an ad pod when one or more of the individuals present are fully attentive. Alternatively, the advertiser may pay different amounts, depending on the level of attentiveness observed in each person present in the audience when the ad is displayed.

A person's reaction to an ad in a first ad pod may be used to determine whether a second, related advertisement, is included in a second ad pod shown to the person later. For example, a person classified as having a negative reaction to a first commercial may not be shown the same commercial, or a related commercial, in a different ad pod shown later during a primary content. Alternatively, a person that responds positively to a commercial may be shown a related ad at a subsequent opportunity during the show or anytime in the future.

In one embodiment, primary content (e.g., a movie or television show) is associated with multiple interruption points in which the ad pod could be inserted. For example, four two-minute advertising pods may be required to be shown with the primary content. The audience data may be evaluated to determine the optimum interruption points for display of the advertising pods.

In another embodiment, a series of related ads may be included in a series of ad pods shown during a primary content. However, the next ad in the series may be shown only once an engagement level indicating a certain level of attentiveness is recorded in association with the first ad presentation.

Personal characteristics of audience members may also be considered when deciding which advertisement to include in an ad pod. The personal characteristics of the audience members include demographic data that may be discerned from image classification or from associating the person with a known personal account. For example, an entertainment company may require that the person submit a name, age, address, and other demographic information to maintain a personal account. The personal account may be associated with a facial recognition program that is used to authenticate the person. Regardless of whether the entertainment company is providing the primary content, the facial recognition record associated with the personal account could be used to identify the person in the audience who is associated with the account. In some situations, all of the audience members may be associated with an account that allows precise demographic information to be associated with each audience member.

Embodiments of the present invention allow advertisers to specify characteristics they want in their target viewer. The advertiser may specify characteristics of the viewer, attention levels, and viewer response. The advertiser may specify how much it is willing to pay for display of the advertisement to viewers meeting different criteria. For example, the advertiser may specify that it is willing to pay $1.00 to a viewer paying full attention and only $0.50 to a viewer paying partial attention. Similarly, the advertiser may be willing to pay a first amount to display the advertisement to an audience member having a specific demographic profile and a lesser amount to an audience member not fitting the specific demographic profile.

In a multiviewer audience, the advertiser may be charged different amounts for each person in the room. With a multiviewer audience, the advertisement with the overall highest return may be included in the ad pod. For example, an advertiser willing to pay $2.00 per view, regardless of demographic profile, to a room of six people would result in a $12.00 return. An advertiser that is willing to pay $4.00 to an individual within a demographic profile, but nothing for users not fitting that profile, would return only $8.00, if only two of the six audience members fit the profile.

Embodiments of the present invention provide a method for locally storing audience data on an entertainment device. The local audience data may be used to provide to an audience data for advertising selection. The audience data may be generated for each of a plurality of persons in a display device's audience. The display device may be communicatively coupled to multiple entertainment devices that output the media content to the display device. Embodiments of the invention may identify content output by different devices and generate audience records based on the combined content.

In one embodiment, audience data is derived from image data that depicts the audience area surrounding the display device. The image data may be received from an imaging device, such as a video camera or depth camera. The audience data may be derived from audio data that detects a person's voice and volume, for example. The audience data may also be based on information stored in a known person's account.

The audience data includes determined levels of engagement with media content. A machine-learning image classifier may determine the levels of engagement by analyzing image data. A person's level of engagement may be classified into one or more categories or levels. The categories may range from not paying attention (i.e., no detectable engagement) to paying full attention (i.e., a high level of engagement), for example.

The audience data may also include audience responses to the media content. A response may be measured by studying biometrics gleaned from the image data. For example, heartbeat and facial flushing may be detected in the image data. A response may also include a change to a person's facial features, body language or movement, as well as audio output originating from a person. All of these responses may be interpreted by the image classifier to determine whether a person likes or dislikes certain media content.

Storing a user profile or other form of audience data locally may enhance user privacy by eliminating a need to communicate the profile data to an advertiser or ad network. The user profile may be analyzed locally to surface only generalized viewing information that is exposed to the advertiser, content provider, or others. In one embodiment, the viewing information is abstracted to a level that prevents identification of the viewer. The user profile information may be encrypted to prevent direct access by an advertiser or other party. In one embodiment, the user is invited to supply a pass code used to form the encryption key. Data in the encrypted user profile may be accessed by a program on the client that analyzes the user profile to classify the viewing record into generalized characteristics or categories of interest to an advertiser. The general characteristics or categories may be exposed to advertisers, content providers, and the like, but the actual viewing record with detailed information remains protected. The general characteristics or categories may be standardized across clients to enable use by advertisers or others that subscribe to consume locally stored information. Storing the user profile locally also conserves network data usage.

Personas are one way to abstract viewing records to protect privacy. In addition to generating and storing audience data, the entertainment device may assign personas to a person or group of persons within the audience area. The persona is an abstraction of the likes and dislikes of a particular person. The persona may be determined and assigned based on a person's determined physical characteristics, stored preferences, viewing histories, and responses to media content. For example, a person who commonly plays video games may be assigned a persona of “video game player.” The personas may be stored in a profile associated with a person or a group of persons. In some embodiments, the persona may be communicated to a server that distributes persona information to advertisers. In response, the server may receive targeted advertisements from advertisers directed toward specific personas. Persons to whom the specific personas have been assigned may then be presented with the targeted advertisements when using the entertainment device.

In one embodiment, a privacy interface is provided. The privacy interface explains how audience data is gathered and used. The audience member is given the opportunity to opt-in or opt-out of all or some uses of the audience data. For example, the audience member may authorize use of explicit audience responses, but opt-out of implicit responses.

As explained in more detail subsequently, audience data and/or viewing records may be abstracted into a persona before sharing with advertisers or otherwise complied. The use of personas maintains the privacy of individual audience members by obscuring personally identifiable information. For example, a viewing record may be recorded as a male, age 25-30, watched commercial YZ and responded positively. The actual viewer is not identified in audience data, even when some information (e.g., age) may be ascertained from a user account that includes personally identified information.

Having briefly described an overview of embodiments of the invention, an exemplary operating environment suitable for use in implementing embodiments of the invention is described below.

### Exemplary Operating Environment

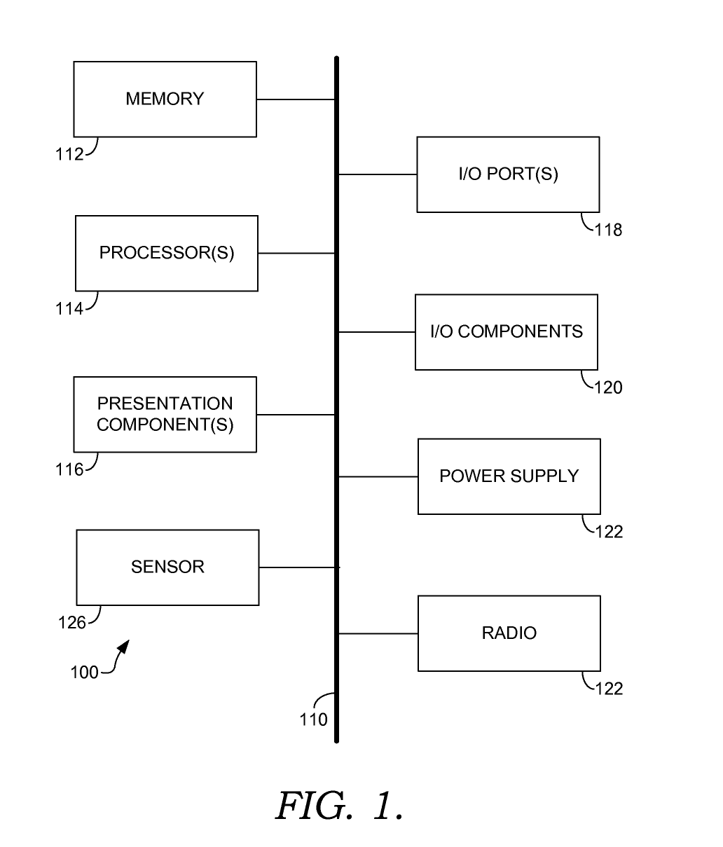

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a person or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Entertainment Environment

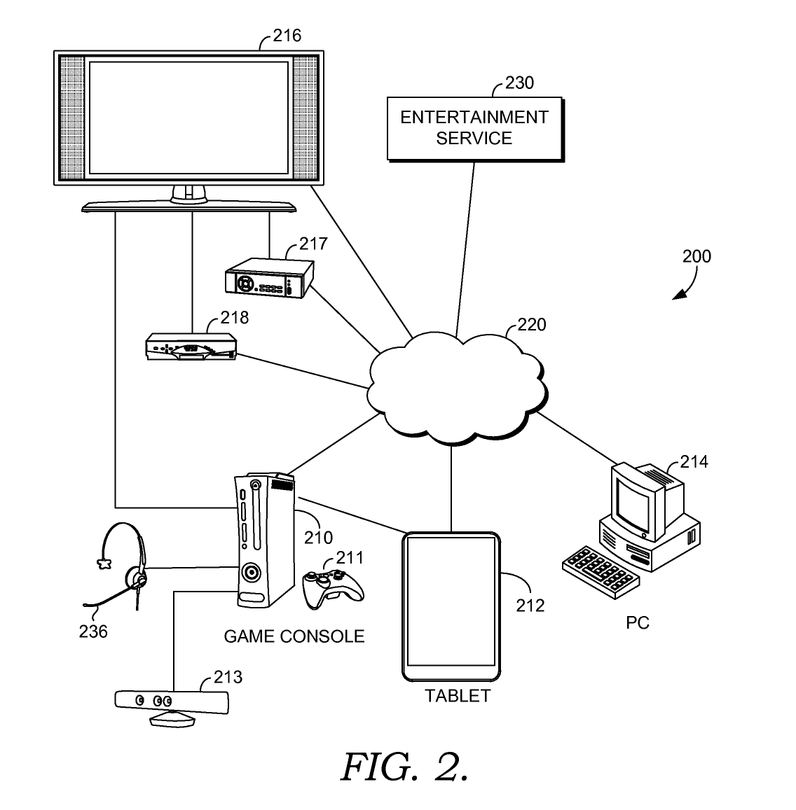

Turning now to FIG. 2, an online entertainment environment 200 is shown, in accordance with an embodiment of the present invention. The online entertainment environment 200 comprises various entertainment devices connected through a network 220 to an entertainment service 230. Exemplary entertainment devices include a game console 210, a tablet 212, a personal computer 214, a digital video recorder 217, a cable box 218, and a television 216. Use of other entertainment devices not depicted in FIG. 2, such as smart phones, is also possible.

The game console 210 may have one or more game controllers communicatively coupled to it. In one embodiment, the tablet 212 may act as an input device for the game console 210 or the personal computer 214. In another embodiment, the tablet 212 is a stand-alone entertainment device. Network 220 may be a wide area network, such as the Internet. As can be seen, most devices shown in FIG. 2 could be directly connected to the network 220. The devices shown in FIG. 2, are able to communicate with each other through the network 220 and/or directly as indicated by the lines connecting the devices.

The controllers associated with game console 210 include a game pad 211, a headset 236, an imaging device 213, and a tablet 212. Tablet 212 is shown coupled directly to the game console 210, but the connection could be indirect through the Internet or a subnet. In one embodiment, the entertainment service 230 helps make a connection between the tablet 212 and the game console 210. The tablet 212 is capable of generating numerous input streams and may also serve as a display output mechanism. In addition to being a primary display, the tablet 212 could provide supplemental information related to primary information shown on a primary display, such as television 216. The input streams generated by the tablet 212 include video and picture data, audio data, movement data, touch screen data, and keyboard input data.

The headset 236 captures audio input from a player and the player's surroundings and may also act as an output device, if it is coupled with a headphone or other speaker.

The imaging device 213 is coupled to game console 210. The imaging device 213 may be a video camera, a still camera, a depth camera, or a video camera capable of taking still or streaming images. In one embodiment, the imaging device 213 includes an infrared light and an infrared camera. The imaging device 213 may also include a microphone, speaker, and other sensors. In one embodiment, the imaging device 213 is a depth camera that generates three-dimensional image data. The three-dimensional image data may be a point cloud or depth cloud. The three-dimensional image data may associate individual pixels with both depth data and color data. For example, a pixel within the depth cloud may include red, green, and blue color data, and X, Y, and Z coordinates. Stereoscopic depth cameras are also possible. The imaging device 213 may have several image-gathering components. For example, the imaging device 213 may have multiple cameras. In other embodiments, the imaging device 213 may have multidirectional functionality. In this way, the imaging device 213 may be able to expand or narrow a viewing range or shift its viewing range from side to side and up and down.

The game console 210 may have image-processing functionality that is capable of identifying objects within the depth cloud. For example, individual people may be identified along with characteristics of the individual people. In one embodiment, gestures made by the individual people may be distinguished and used to control games or media output by the game console 210. The game console 210 may use the image data, including depth cloud data, for facial recognition purposes to specifically identify individuals within an audience area. The facial recognition function may associate individuals with an account associated with a gaming service or media service, or used for login security purposes, to specifically identify the individual.

In one embodiment, the game console 210 uses microphone, and/or image data captured through imaging device 213 to identify content being displayed through television 216. For example, a microphone may pick up the audio data of a movie being generated by the cable box 218 and displayed on television 216. The audio data may be compared with a database of known audio data and the data identified using automatic content recognition techniques, for example. Content being displayed through the tablet 212 or the PC 214 may be identified in a similar manner. In this way, the game console 210 is able to determine what is presently being displayed to a person regardless of whether the game console 210 is the device generating and/or distributing the content for display.

The game console 210 may include classification programs that analyze image data to generate audience data. For example, the game console 210 may determine number of people in the audience, audience member characteristics, levels of engagement, and audience response.

In another embodiment, the game console 210 includes a local storage component. The local storage component may store user profiles for individual persons or groups of persons viewing and/or reacting to media content. Each user profile may be stored as a separate file, such as a cookie. The information stored in the user profiles may be updated automatically. Personal information, viewing histories, viewing selections, personal preferences, the number of times a person has viewed known media content, the portions of known media content the person has viewed, a person's responses to known media content, and a person's engagement levels in known media content may be stored in a user profile associated with a person. As described elsewhere, the person may be first identified before information is stored in a user profile associated with the person. In other embodiments, a person's characteristics may be first recognized and mapped to an existing user profile for a person with similar or the same characteristics. Demographic information may also be stored. Each item of information may be stored as a “viewing record” associated with a particular type of media content. As well, viewer personas, as described below, may be stored in a user profile.

Storing the user profile locally may enhance user privacy by eliminating a need to communicate the profile data to an advertiser or ad network. The user profile may be analyzed locally to surface only generalized viewing information that is exposed to the advertiser, content provider, or others. In one embodiment, the viewing information is abstracted to a level that prevents identification of the viewer. The user profile information may be encrypted to prevent direct access by an advertiser or other party. In one embodiment, the user is invited to supply a pass code used to form the encryption key. Data in the encrypted user profile may be accessed by a program on the client that analyzes the user profile to classify the viewing record into generalized characteristics or categories of interest to an advertiser. The general characteristics or categories may be exposed to advertisers, content providers, and the like, but the actual viewing record with detailed information remains protected. The general characteristics or categories may be standardized across clients to enable use by advertisers or others that subscribe to consume locally stored information. Storing the user profile locally also conserves network data usage.

Entertainment service 230 may comprise multiple computing devices communicatively coupled to each other. In one embodiment, the entertainment service is implemented using one or more server farms. The server farms may be spread out across various geographic regions including cities throughout the world. In this scenario, the entertainment devices may connect to the closest server farms. Embodiments of the present invention are not limited to this setup. The entertainment service 230 may provide primary content and secondary content. Primary content may include television shows, movies, and video games. Secondary content may include advertisements, social content, directors' information and the like.

FIG. 2 also includes a cable box 218 and a DVR 217. Both of these devices are capable of receiving content through network 220. The content may be on-demand or broadcast as through a cable distribution network. Both the cable box 218 and DVR 217 have a direct connection with television 216. Both devices are capable of outputting content to the television 216 without passing through game console 210. As can be seen, game console 210 also has a direct connection to television 216. Television 216 may be a smart television that is capable of receiving entertainment content directly from entertainment service 230. As mentioned, the game console 210 may perform audio analysis to determine what media title is being output by the television 216 when the title originates with the cable box 218, DVR 217, or television 216.

### Exemplary Advertising and Content Service

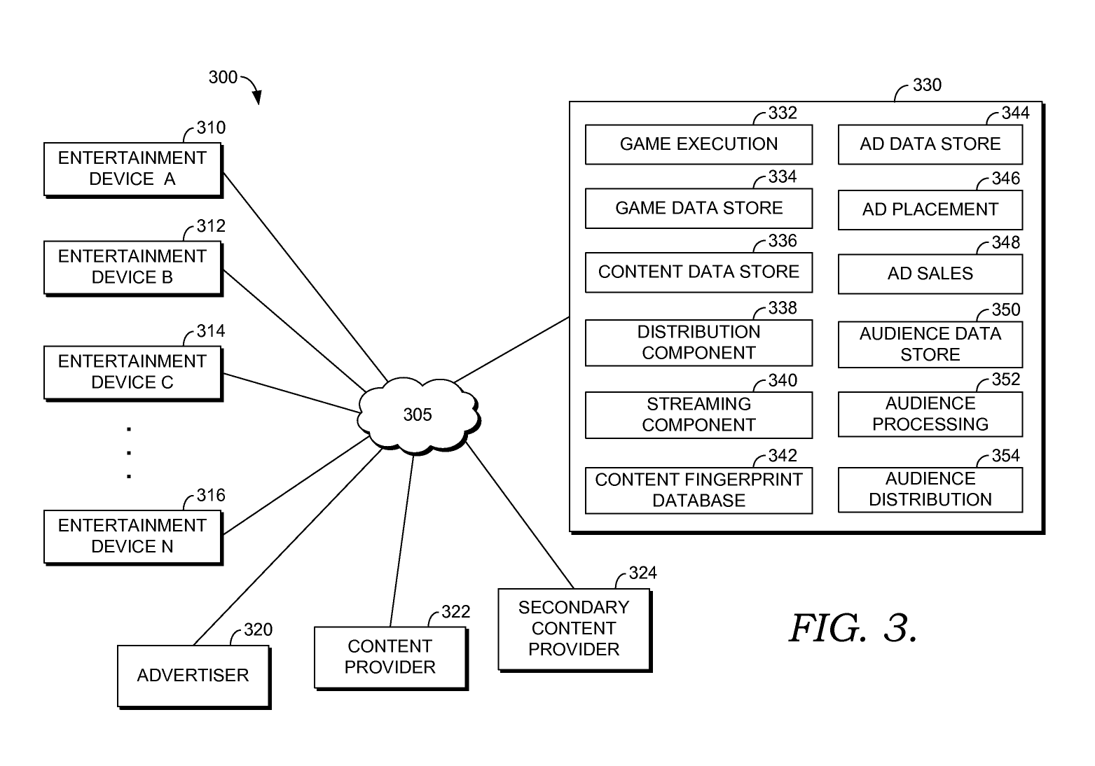

Turning now to FIG. 3, a distributed entertainment environment 300 is shown, in accordance with an embodiment of the present invention. The entertainment environment 300 includes entertainment device A 310, entertainment device B 312, entertainment device C 314, and entertainment device N 316 (hereafter entertainment devices 310-316). Entertainment device N 316 is intended to represent that there could be an almost unlimited number of clients connected to network 305. The entertainment devices 310-316 may take different forms. For example, the entertainment devices 310-316 may be game consoles, televisions, DVRs, cable boxes, personal computers, tablets, or other entertainment devices capable of outputting media. In addition, the entertainment devices 310-316 are capable of gathering viewer data through an imaging device, similar to imaging device 213 of FIG. 2 that was previously described. The imaging device could be built into a client, such as a web cam and microphone, or could be a stand-alone device.

In one embodiment, the entertainment devices 310-316 include a local storage component configured to store personal profiles for one or more persons. The local storage component is described in greater detail above with reference to the game console 210. The entertainment devices 310-316 may include classification programs that analyze image data to generate audience data. For example, the entertainment devices 310-316 may determine how many people are in the audience, audience member characteristics, levels of engagement, and audience response.

Network 305 is a wide area network, such as the Internet. Network 305 is connected to advertiser 320, content provider 322, and secondary content provider 324. The advertiser 320 distributes advertisements to entertainment devices 310-316. The advertiser 320 may also cooperate with entertainment service 330 to provide advertisements. The content provider 322 provides primary content such as movies, video games, and television shows. The primary content may be provided directly to entertainment devices 310-316 or indirectly through entertainment service 330.

Secondary content provider 324 provides content that compliments the primary content. Secondary content may be a director's cut, information about a character, game help information, and other content that compliments the primary content. The same entity may generate both primary content and secondary content. For example, a television show may be generated by a director that also generates additional secondary content to compliment the television show. The secondary content and primary content may be purchased separately and could be displayed on different devices. For example, the primary content could be displayed through a television while the secondary content is viewed on a companion device, such as a tablet. The advertiser 320, content provider 322, and secondary content provider 324 may stream content directly to entertainment devices or seek to have their content distributed by a service, such as entertainment service 330.

Entertainment service 330 provides content and advertisements to entertainment devices. The entertainment service 330 is shown as a single block. In reality, the functions should be widely distributed across multiple devices. In embodiments of the present invention, the various features of entertainment service 330 described herein may be provided by multiple entities and components. The entertainment service 330 comprises a game execution environment 332, a game data store 334, a content data store 336, a distribution component 338, a streaming component 340, a content recognition database 342, an ad data store 344, an ad placement component 346, an ad sales component 348, an audience data store 350, an audience processing component 352, and an audience distribution component 354. As can be seen, the various components may work together to provide content, including games, advertisements, and media titles to a client, and capture audience data. The audience data may be used to specifically target advertisements and/or content to a person. The audience data may also be aggregated and shared with or sold to others.

The game execution environment 332 provides an online gaming experience to a client device. The game execution environment 332 comprises the gaming resources required to execute a game. The game execution environment 332 comprises active memory along with computing and video processing. The game execution environment 332 receives gaming controls, such as controller input, through an I/O channel and causes the game to be manipulated and progressed according to its programming. In one embodiment, the game execution environment 332 outputs a rendered video stream that is communicated to the game device. Game progress may be saved online and associated with an individual person that has an ID through a gaming service. The game ID may be associated with a facial pattern.

The game data store 334 stores game code for various game titles. The game execution environment 332 may retrieve a game title and execute it to provide a gaming experience. Alternatively, the content distribution component 338 may download a game title to an entertainment device, such as entertainment device A 310.

The content data store 336 stores media titles, such as songs, videos, television shows, and other content. The distribution component 338 may communicate this content from content data store 336 to the entertainment devices 310-316. Once downloaded, an entertainment device may play the content on or output the content from the entertainment device. Alternatively, the streaming component 340 may use content from content data store 336 to stream the content to the person.

The content recognition database 342 includes a collection of audio clips associated with known media titles that may be compared to audio input received at the entertainment service 330. As described above, the received audio input (e.g., received from the game console 210 of FIG. 2) is mapped to the library of known media titles. Upon mapping the audio input to a known media title, the source of the audio input (i.e., the identity of media content) may be determined. The identified media title/content is then communicated back to the entertainment device (e.g., the game console) for further processing. Exemplary processing may include associating the identified media content with a person that viewed or is actively viewing the media content and storing the association as a viewing record.

The entertainment service 330 also provides advertisements that may be included within an audience-aware ad pod. Advertisements available for distribution may be stored within ad data store 344. The advertisements may be presented as an overlay in conjunction with primary content. The advertisements may be partial or full-screen advertisements that are presented between segments of a media presentation or between the beginning and end of a media presentation, such as a television commercial. The advertisements may be associated with audio content. Additionally, the advertisements may take the form of secondary content that is displayed on a companion device in conjunction with a display of primary content. The advertisements may also be presented when a person associated with a targeted persona is located in the audience area and/or is logged in to the entertainment service 330, as further described below.

The ad placement component 346 determines when an advertisement should be displayed to a person and/or what advertisement should be displayed. The ad placement component 346 may communicate display triggers to an entertainment client that uses the display triggers to decide whether to include an ad within an audience-aware ad pod. The ad placement component 346 may consume real-time audience data and automatically place an advertisement associated with a highest-bidding advertiser in front of one or more viewers because the audience data indicates that the advertiser's bidding criteria is satisfied. For example, an advertiser may wish to display an advertisement to men present in Kansas City, Mo. When the audience data indicates that one or more men in Kansas City are viewing primary content, an ad could be served with that primary content. The ad may be inserted into streaming content or downloaded to the various entertainment devices along with triggering mechanisms or instructions on when the advertisement should be displayed to the person. The triggering mechanisms may specify desired audience data that triggers display of the ad or inclusion of the ad in an ad pod.

The ad sales component 348 interacts with advertisers 320 to set a price for displaying an advertisement. In one embodiment, an auction is conducted for various advertising space. The auction may be a real-time auction in which the highest bidder is selected when a viewer or viewing opportunity satisfies the advertiser's criteria.

The audience data store 350 aggregates and stores audience data received from entertainment devices 310-316. The audience data may first be parsed according to known types or titles of media content. Each item of audience data that relates to a known type or title of media content is a viewing record for that media content. Viewing records for each type of media content may be aggregated, thereby generating viewing data. The viewing data may be summarized according to categories. Exemplary categories include a total number of persons that watched the content, the average number of persons per household that watched the content, a number of times certain persons watched the content, a determined response of people toward the content, a level of engagement of people in the media title, a length of time individuals watched the content, the common distractions that were ignored or engaged in while the content was being displayed, and the like. The viewing data may similarly be summarized according to types of persons that watched the known media content. For example, personal characteristics of the persons, demographic information about the persons, and the like may be summarized within the viewing data.

The audience processing component 352 may build and assign personas using the audience data and a machine-learning algorithm. A persona is an abstraction of a person or groups of people that describes preferences or characteristics about the person or groups of people. The personas may be based on media content the persons have viewed or listened to, as well as other personal information stored in a user profile on the entertainment device (e.g., game console) and associated with the person. For example, the persona could define a person as a female between the ages of 20 and 35 having an interest in science fiction, movies, and sports. Similarly, a person that always has a positive emotional response to car commercials may be assigned a persona of “car enthusiast.” More than one persona may be assigned to an individual or group of individuals. For example, a family of five may have a group persona of “animated film enthusiasts” and “football enthusiasts.” Within the family, a child may be assigned a persona of “likes video games,” while the child's mother may be assigned a person of “dislikes video games.” It will be understood that the examples provided herein are merely exemplary. Any number or type of personas may be assigned to a person.

The audience distribution component 354 may distribute audience data to content providers, advertisers, or other interested parties. For example, the audience distribution component 354 could provide information indicating that 300,000 discrete individuals viewed a television show in a geographic region. The audience data could be derived from image data received at each entertainment device. In addition to the number of people that viewed the media content, more granular information could be provided. For example, the total persons giving full attention to the content could be provided. In addition, response data for people could be provided. To protect the identity of individual persons, only a persona assigned to a person may be exposed and distributed to advertisers. A value may be placed on the distribution, as a condition on its delivery, as described above. The value may also be based on the amount, type, and dearth of viewing data delivered to an advertiser or content publisher.

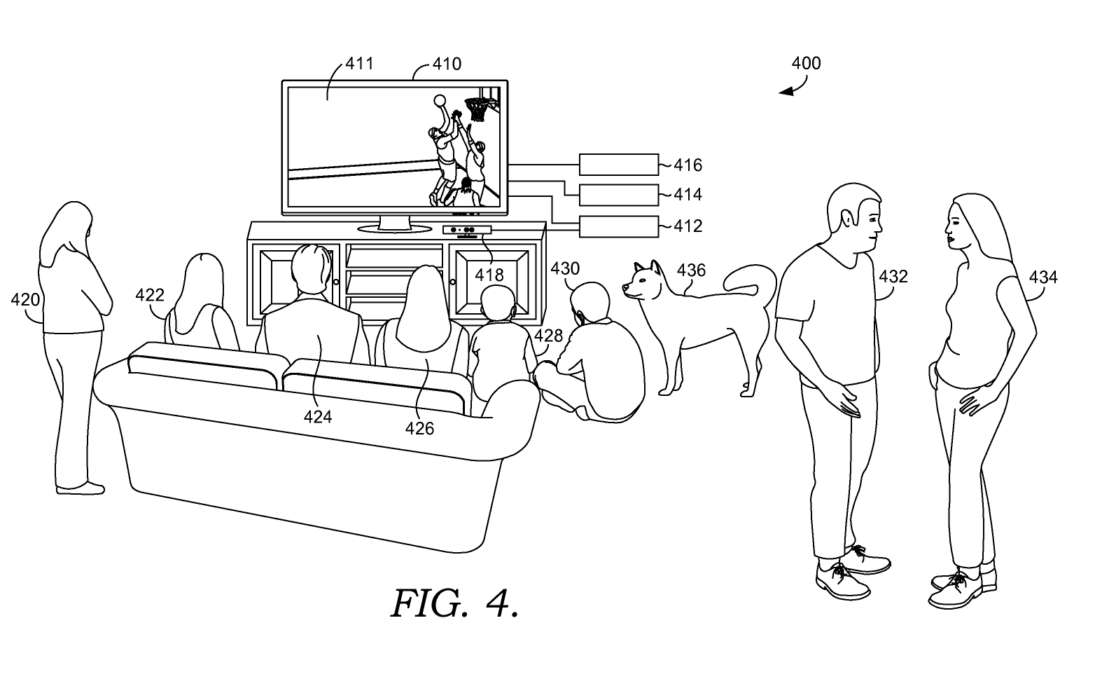

Turning now to FIG. 4, an audience area 400 that includes a group of people is shown, in accordance with an embodiment of the present invention. The audience area is the area in front of the display device 410. In one embodiment, the audience area 400 comprises the area from which a person can see the content. In another embodiment, the audience area 400 comprises the area within a viewing range of the imaging device 418. In most embodiments, however, the viewing range of the imaging device 418 overlaps with the area from which a person can see content on the display device 410. If the content is only audio content, then the audience area is the area where the person may hear the content.

Content is provided to the audience area by an entertainment system that comprises a display device 410, a game console 412, a cable box 414, a DVD player 416, and an imaging device 418. The game console 412 may be similar to game console 210 of FIG. 2 described previously. The cable box 414 and the DVD player 416 may stream content from an entertainment service, such as entertainment service 330 of FIG. 3, to the display device 410 (e.g., television). The game console 412, cable box 414, and the DVD player 416 are all coupled to the display device 410. These devices may communicate content to the display device 410 via a wired or wireless connection, and the display device 410 may display the content. In some embodiments, the content shown on the display device 410 may be selected by one or more persons within the audience. For example, a person in the audience may select content by inserting a DVD into the DVD player 416 or select content by clicking, tapping, gesturing, or pushing a button on a companion device (e.g., a tablet) or a remote in communication with the display device 410. Content selected for viewing may be tracked and stored on the game console 412.

The imaging device 418 is connected to the game console 412. The imaging device 418 may be similar to imaging device 213 of FIG. 2 described previously. The imaging device 418 captures image data of the audience area 400. Other devices that include imaging technology, such as the tablet 212 of FIG. 2, may also capture image data and communicate the image data to the game console 412 via a wireless or wired connection. In FIGS. 4-6, the game console analyzes image data to generate audience data. However, embodiments are not limited to performance by a game console. Other entertainment devices could process imaging data to generate audience data. For example, a television, cable box, stereo receiver, or other entertainment device could analyze imaging data to generate audience data, viewing records, viewing data and other derivates of the image data describing the audience.

In one embodiment, audience data may be gathered through image processing. Audience data may include a detected number of persons within the audience area 400. Persons may be detected based on their form, appendages, height, facial features, movement, speed of movement, associations with other persons, biometric indicators, and the like. Once detected, the persons may be counted and tracked so as to prevent double counting. The number of persons within the audience area 400 also may be automatically updated as people leave and enter the audience area 400.

Audience data may similarly include a direction each audience member is facing. Determining the direction persons are facing may, in some embodiments, be based on whether certain facial or body features are moving or detectable. For example, when certain features, such as a person's cheeks, chin, mouth and hairline are detected, they may indicate that a person is facing the display device 410. Audience data may include a number of persons that are looking toward the display device 410, periodically glancing at the display device 410, or not looking at all toward the display device 410. In some embodiments, a period of time each person views specific media presentations may also comprise audience data.

As an example, audience data may indicate that an individual 420 is standing in the background of the audience area 400 while looking at the display device 410. Individuals 422, 424, 426, and child 428 and child 430 may also be detected and determined to be all facing the display device 410. A individual 432 and a individual 434 may be detected and determined to be looking away from the television. The dog 436 may also be detected, but characteristics (e.g., short stature, four legs, and long snout) about the dog 436 may not be stored as audience data because they indicate that the dog 436 is not a person.

Additionally, audience data may include an identity of each person within the audience area 400. Facial recognition technologies may be utilized to identify a person within the audience area 400 or to create and store a new identity for a person. Additional characteristics of the person (e.g., form, height, weight) may similarly be analyzed to identify a person. In one embodiment, the person's determined characteristics may be compared to characteristics of a person stored on the display device 410 in a user profile. If the determined characteristics match those in a stored user profile, the person may be identified as a person associated with the user profile.

Audience data may include personal information associated with each person in the audience area. Exemplary personal characteristics include an estimated age, a race, a nationality, a gender, a height, a weight, a disability, a medical condition, a likely activity level of (e.g., active or relatively inactive), a role within a family (e.g., father or daughter), and the like. For example, based on the image data, an image processor may determine that individual 420 is a woman of average weight. Similarly, analyzing the width, height, bone structure, and size of individual 432 may lead to a determination that the individual 432 is a male. Personal information may also be derived from stored user profile information. Such personal information may include an address, a name, an age, a birth date, an income, one or more viewing preferences (e.g., movies, games, and reality television shows) of or login credentials for each person. In this way, audience data may be generated based on both processed image data and stored personal profile data. For example, if individual 434 is identified and associated with a personal profile of a 13-year-old, processed image data that classifies individual 434 as an adult (i.e., over 18 years old) may be disregarded as inaccurate.

The audience data also comprises an identification of the primary content being displayed when image data is captured at the imaging device 418. The primary content may, in one embodiment, be identified because it is fed through the game console 412. In other embodiments, and as described above, audio output associated with the display device 410 may be received at a microphone associated with the game console 412. The audio output is then compared to a library of known content and determined to correspond to a known media title or a known genre of media title (e.g., sports, music, movies, and the like). As well, other cues (e.g., whether the person appears to be listening to as opposed to watching a media presentation) may be analyzed to determine the identity of the media content (e.g., a song as opposed to the soundtrack to a movie). Thus, audience data may indicate that primary content 411 (a basketball game) was being displayed to individuals 420, 422, 424, 426, 428, 430, 432, and 434 when images of the individuals were captured. The audience data may also include a mapping of the image data to the exact segment of the primary content (e.g., 30 min from start of basketball game) being displayed when the image data was captured.

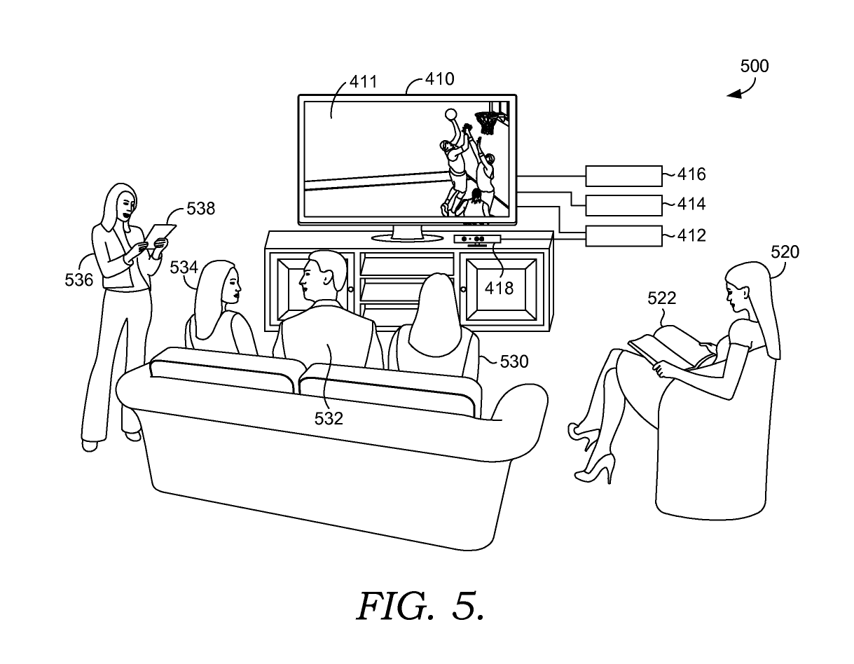

Turning now to FIG. 5, an audience area depicting audience members' levels of engagement is shown, in accordance with an embodiment of the present invention. The entertainment system is identical to that shown in FIG. 4, but the audience members have changed. Image data captured at the imaging device 418 may be processed similarly to how it was processed with reference to FIG. 4. However, in this illustrative embodiment, the image data may be processed to generate audience data that indicates a level of engagement of and/or attention paid by the audience toward the primary content 411 (e.g., the basketball game).

An indication of the level of engagement of a person may be generated based on detected traits of or actions taken by the person, such as facial features, body positioning, and body movement. For example, the movement of a person's eyes, the direction the person's body is facing, the direction the person's face is turned, whether the person is engaged in another task (e.g., talking on the phone), whether the person is talking, the number of additional persons within the audience area 500, and the movement of the person (e.g., pacing, standing still, sitting, or lying down) are traits of and/or actions taken by a person that may be distilled from the image data. The determined traits may then be mapped to predetermined categories or levels of engagement (e.g., a high level of engagement or a low level of engagement). Any number of categories or levels of engagement may be created, and the examples provided herein are merely exemplary.

In another embodiment, a level of engagement may additionally be associated with one or more predetermined categories of distractions. In this way, traits of or actions taken by a person may be mapped to both a level of engagement and a type of distraction. Exemplary actions that indicate a distraction include engaging in conversation, using more than one display device (e.g., the display device 510 and a companion device), reading a book, playing a board game, falling asleep, getting a snack, leaving the audience area 500, walking around, and the like. Exemplary distraction categories may include “interacted with other persons,” “interacted with an animal,” “interacted with other display devices,” “took a brief break,” and the like.

Other input that may be used to determine a person's level of engagement is audio data. Microphones associated with the game console 412 may pick up conversations or sounds from the audience. The audio data may be interpreted and determined to be responsive to (i.e., related to or directed at) the media presentation or nonresponsive to the media presentation. The audio data may be associated with a specific person (e.g., a person's voice). As well, signal data from companion devices may be collected to generate audience data. The signal data may indicate, in greater detail than the image data, a type or identity of a distraction, as described below.

Thus, the image data gathered through imaging device 418 may be analyzed to determine that individual 520 is reading a paper 522 and is therefore distracted from the content shown on display device 510. Individual 536 is viewing tablet 538 while the content is being displayed through display device 510. In addition to observing the person holding the tablet, signal data may be analyzed to understand what the person is doing on the tablet. For example, the person could be surfing the Web, checking e-mail, checking a social network site, or performing some other task. However, the individual 536 could also be viewing secondary content that is related to the primary content 411 (i.e., basketball game) shown on display device 510. What the person doing on tablet 538 may cause a different level of engagement to be associated with the person. For example, if the activity is totally unrelated (i.e., the activity is not secondary content), then the level of engagement mapped to the person's action (i.e., looking at the tablet) and associated with the person may be determined to be quite low. On the other hand, if the person is viewing secondary content that compliments the primary content, then the individual 536's action of looking at the tablet may be mapped to a somewhat higher level of engagement.

Individuals 532 and 534 are carrying on a conversation with each other but are not otherwise distracted because they are seated in front of the display device 510. If, however, audio input from individuals 532 and 534 indicate that they are speaking with each other while seated in front of the display device 510, their actions may be mapped to an intermediate level of engagement. Only individual 530 is viewing the primary content 411 and not otherwise distracted. Accordingly, a high level of engagement may be associated with individual 530 and/or the media content being displayed.

Determined distractions and levels of engagement of a person may additionally be associated with particular portions of image data, and thus, corresponding portions of media content. As mentioned elsewhere, such audience data may be stored locally on the game console 412 or communicated to a server for remote storage and distribution. The audience data may be stored as a viewing record for the media content. As well, the audience data may be stored in a user profile associated with the person for whom a level of engagement or distractions was determined.

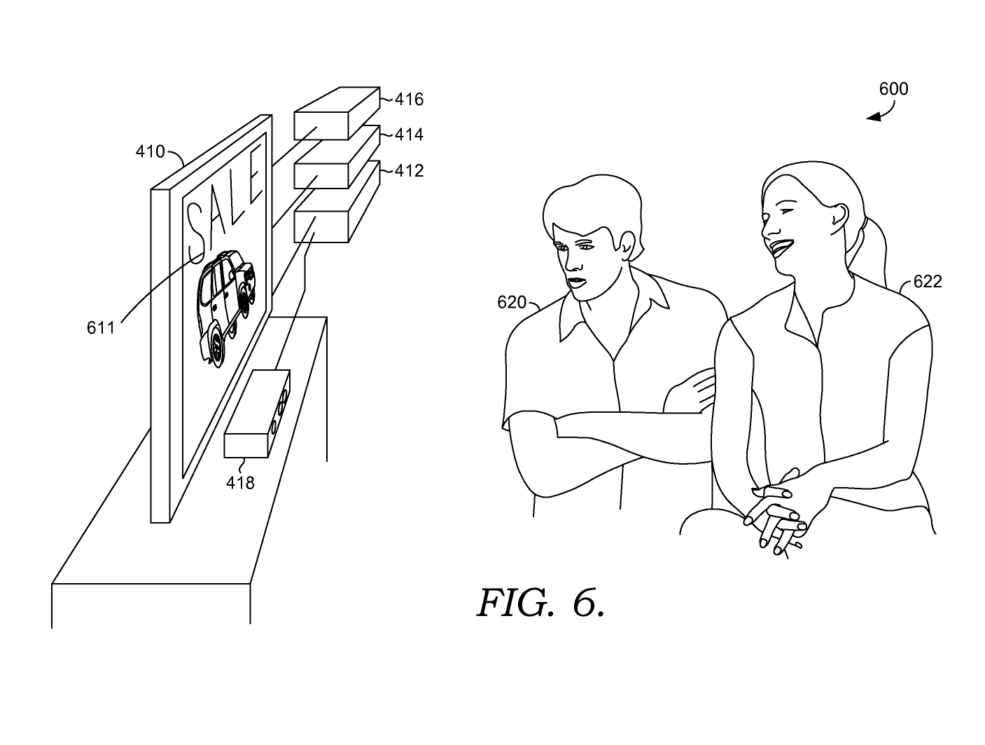

Turning now to FIG. 6, a person's reaction to media content is classified and stored in association with the viewing data. The entertainment setup shown in FIG. 6 is the same as that shown in FIG. 4. However, the primary content 611 is different. In this case, the primary content is a car commercial indicating a sale. In addition to detecting that individuals 620 and 622 are viewing the content and are paying full attention to the content, the persons' responses to the car commercial may be measured through one or more methods and stored as audience data.

In one embodiment, a person's response may be gleaned from the images and/or audio originating from the person (e.g., the person's voice). Exemplary responses include smiling, frowning, wide eyes, glaring, yelling, speaking softly, laughing, crying, and the like. Other responses may include a change to a biometric reading, such as an increased or a decreased heart rate, facial flushing, or pupil dilation. Still other responses may include movement, or a lack thereof, for example, pacing, tapping, standing, sitting, darting one's eyes, fixing one's eyes, and the like. Each response may be mapped to one or more predetermined emotions, such as happiness, sadness, excitement, boredom, depression, calmness, fear, anger, confusion, disgust, and the like. For example, when a person frowns, her frown may be mapped to an emotion of dissatisfaction or displeasure. In embodiments, mapping a person's response to an emotion may additionally be based on the length of time the person held the response or the pronouncement of the person's response. As well, a person's response may be mapped to more than one emotion. For example, a person's response (e.g., smiling and jumping up and down) may indicate that the person is both happy and excited. Additionally, the predetermined categories of emotions may include tiers or spectrums of emotions. Baseline emotions of a person may also be taken into account when mapping a person's response to an emotion. For example, if the person rarely shows detectable emotions, a detected “happy” emotion for the person may be elevated to a higher “tier” of happiness, such as “elation.” As well, the baseline may serve to inform determinations about the attentiveness of the person toward a particular media title.

In some embodiments, only responses and determined emotions that are responsive to the media content being displayed to the person are associated with the media content. Responsiveness may be related to a determined level of engagement of a person, as described above. Thus, responsiveness may be determined based on the direction the person is looking when a title is being displayed. For example, a person that is turned away from the display device is unlikely to be reacting to content being displayed on the display device. Responsiveness may similarly be determined based on the number and type of distractions located within the viewing area of the display device. Similarly, responsiveness may be based on an extent to which a person is interacting with or responding to distractions. For example, a person who is talking on the phone, even though facing and looking at a display screen of the display device, may be experiencing an emotion unrelated to the media content being displayed on the screen. As well, responsiveness may be determined based on whether a person is actively or has recently changed a media title that is being displayed (i.e., a person is more likely to be viewing content he or she just selected to view). It will be understood that responsiveness can be determined in any number of ways by utilizing machine-learning algorithms, and the examples provided herein are meant only to be illustrative.

Thus, returning to FIG. 6, the image data may be utilized to determine responses of individual 622 and individual 620 to the primary content 611. Individual 622 may be determined to have multiple responses to the car commercial, each of which may be mapped to the same or multiple emotions. For example, the individual 622 may be determined to be smiling, laughing, blinking normally, sitting, and the like. All of these reactions, alone and/or in combination, may lead to a determination that the individual 622 is pleased and happy. This is assumed to be a reaction to the primary content 611 and recorded in association with the display event. By contrast, individual 620 is not smiling, has lowered eyebrows, and is crossing his arms, indicating that the individual 620 may be angry or not pleased with the car commercial.

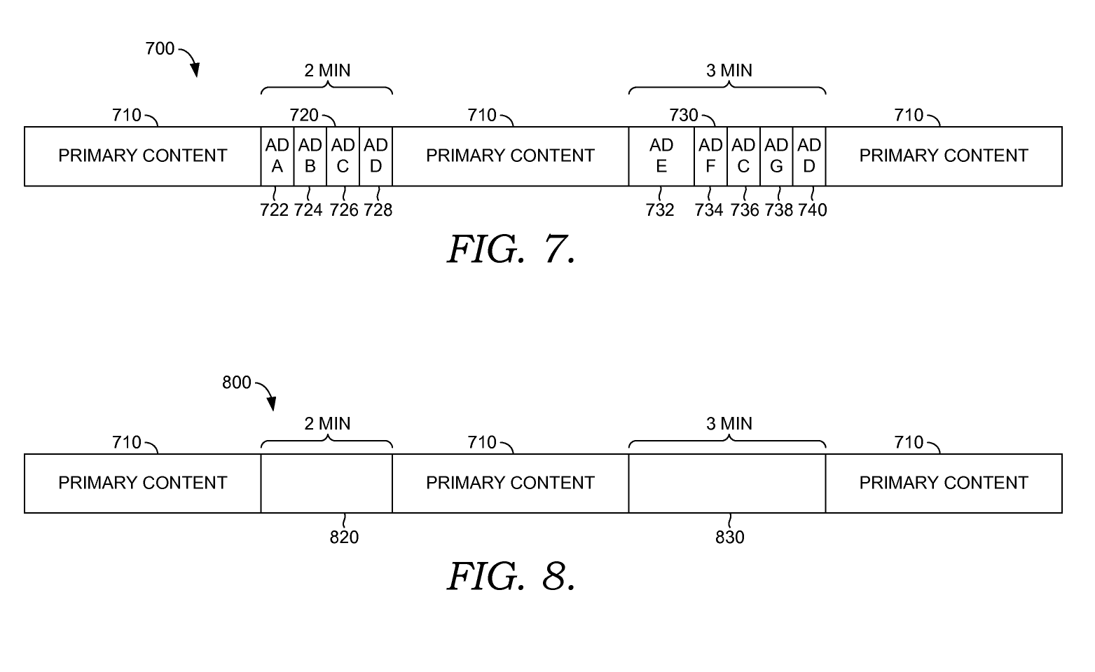

FIGS. 7-11 show representations of media presentations that include audience-aware ad pods. The audience-aware ad pods may be used to organize a group of audience-aware advertisements or a combination of default advertisements and audience-aware ads. The audience-aware ads are selected based on current audience data on a screen-by-screen basis. The default advertising is not based on current audience data, but may be selected using past viewing records associated with a screen, aggregate viewing data for a media presentation (e.g., a television show), and the anticipated audience for a media presentation.

The media presentations may be communicated from a content provider to one or many entertainment clients. For example, the media presentation may be a video-on-demand presentation to a single audience or a broadcast television show communicated to all devices within a distribution area. For example, the media presentation may be communicated via a cable provider, satellite, or terrestrial broadcast. The audience-aware ad pods may take different forms

Turning now to FIG. 7, a media presentation 700 with embedded audience-aware ad pods is shown, in accordance with an embodiment of the present invention. The audience-aware ad pods 720 and 730 include default advertisements that may be replaced by the entertainment client with audience-aware ads. The inclusion of default advertisements allows the same media presentation to be broadcast to both audience-aware enabled entertainment clients and nonenabled entertainment clients. If not audience-aware, the entertainment client will display the default advertisement. An audience-aware enabled entertainment client may replace one or more of the default advertisements. For example, the default advertisement may be the optimum advertisement for a particular audience. An entertainment client displaying the media presentation to a different audience may replace the default advertisement with an advertisement paying a better return for the different audience.

The media presentation 700 includes primary content 710. The primary content could be a movie, game, television show, or the like. The media presentation 700 also includes audience-aware advertising pods 720 and 730. Audience-aware advertising pod 720 is two minutes in duration, while audience-aware advertising pod 730 is three minutes in duration. In this example, each advertising pod interrupts the primary content, but could also be shown at the beginning or end.

Audience-aware advertising pod 720 includes four default advertisements that are each thirty seconds in duration. The default advertisements include ad A 722, ad B 724, ad C 726, and ad D 728. The audience-aware advertising pod 730 includes ad E 732, ad F 734, ad C 736, ad G 738, and ad D 740. Ad E 732 is one minute in duration, while the rest of the advertisements are thirty seconds each. As can be seen, ad C 736 and ad D 740 were shown previously in audience-aware ad pod 720.

Embodiments of the present invention select ads for inclusion in the ad pods 720 and 730 based on the primary content 710 and audience data. The contents of each ad pod may include different advertisements within the ad pod depending on the specific audience. Each entertainment client generates audience data, thus each entertainment client could show a unique mix of advertisements within an ad pod. In one embodiment, some of the default ads may not be replaced and are shown to all viewers while other advertisements may be replaced with ads that are selected on a per-presentation basis.

Turning now to FIG. 8, a media presentation having empty advertising pods is shown, in accordance with an embodiment of the present invention. As mentioned, the advertising-aware advertising pods may be populated with advertisements that suit each audience instance. The media presentation 800 could be received by an entertainment client and the ad pods populated with advertisements to match media presentation and specific audience at the entertainment client.

In contrast to the ad pods in FIG. 7, the audience-aware advertising pods 820 and 830 are empty. In this case, the ad pods 820 and 830 are a fixed duration within the overall media presentation but do not include any advertisements or slots for advertisements. This allows advertisements of any length to be inserted within the advertising pod. For example, advertising pod 820 could include a single advertisement with a maximum length of two minutes. Alternatively, advertisements of different durations, including variable duration ads may be inserted. For example, an advertisement of variable duration could be shown with a commitment to consume the first 15 seconds of advertising pod 820. Upon registering a positive or negative response, the advertisements could be discontinued or continued at the 15-second point. If discontinued, other advertisements could be selected in real time for inclusion within the advertising pod 820.

Advertising pod 830 is similar. The same ad shown in ad pod 820 could be shown in ad pod 830 and advertisements of any duration may be selected to fill the three-minute duration of audience-aware ad pod 830.

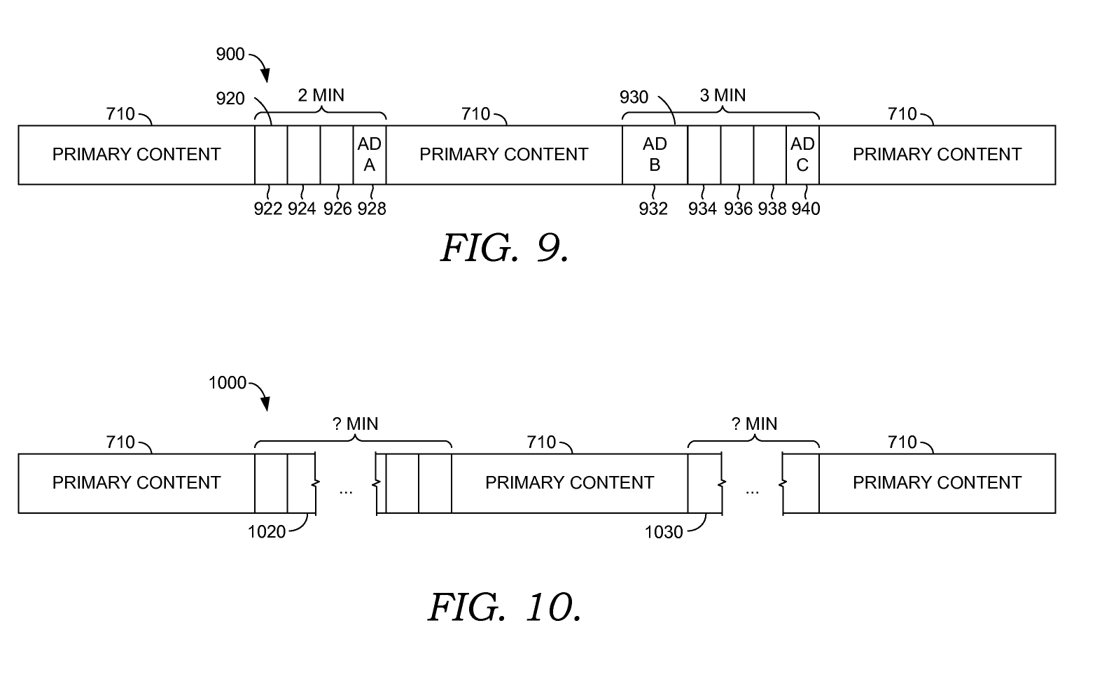

Turning now to FIG. 9, a media presentation 900 having partially populated audience-aware ad pods is shown, in accordance with an embodiment of the present invention. The media presentation 900 could be received by an entertainment client. The media presentation 900 could be generated by a content distributor such as a television station. The media presentation 900 may be broadcast with the primary content 710 and audience-aware advertising pods 920 and 930 included in fixed positions within the primary content. In addition, the advertising pod 920 includes a fixed 30-second slot 922, a fixed 30-second slot 924, and a fixed 30-second slot 926. In addition, ad A 928 is inserted in the final advertising slot within ad pod 920. The fixed ad A 928 will be shown to all audiences that receive the media presentation 900. Embodiments are not limited to fixed slots, but fixed time slots may be used within an audience-aware advertising pod.

Similarly, ad pod 930 includes prepopulated ad B 932, and prepopulated ad C 940. Ad slots 934, 936, and 938 are available for real-time insertion of advertisements. In one embodiment, the advertisements available for insertion are provided to the entertainment client by the content provider.

Turning now to FIG. 10, a media presentation 1000 having flexible-duration audience-aware ad pods is shown, in accordance with an embodiment of the present invention. The media presentation 1000 includes audience-aware ad pod 1020 and ad pod 1030 of variable duration. The variable duration may be determined based on the present audience characteristics and response. The duration may be determined in real time based on audience engagement and attention levels. In addition to the duration of the ad pod, the ads may be selected for insertion within the ad pod based on the same audience data.

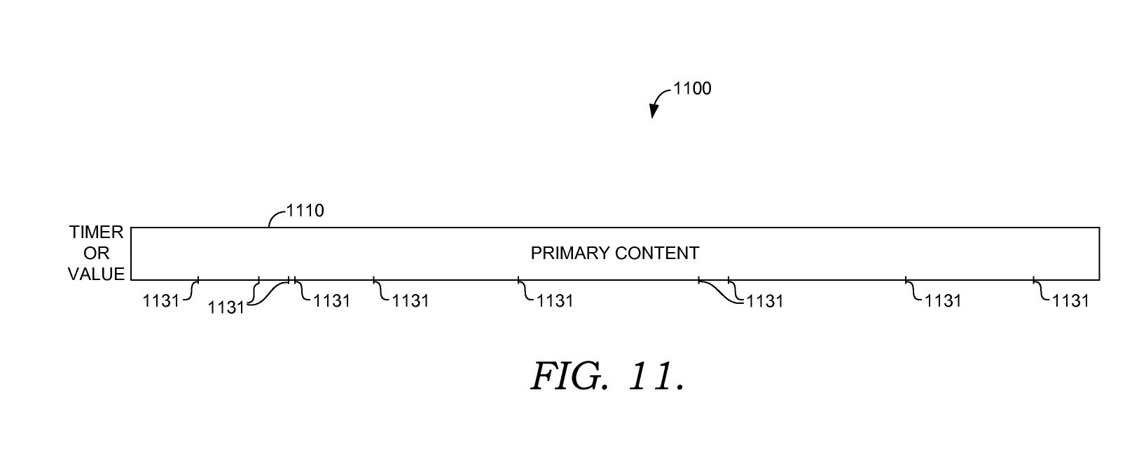

Turning now to FIG. 11, a media presentation 1100 having multiple insertion points is shown, in accordance with the embodiment of the present invention. The primary content may be communicated from a content provider to an entertainment client. The primary content may be a television show, game, movie, or the like. The primary content 1110 includes multiple insertion points 1131. Each insertion point is a potential place where an audience-aware ad pod may be displayed. For example, the insertion points may designate a scene change or transition within the primary content 1110 that makes it suitable for an interruption.

In one embodiment, the primary content 1110 is provided with the agreement that advertisements of a certain duration are inserted into the content by the entertainment client using audience data. The audience data is also used to determine the best insertion point. In general, the insertion point may be selected based on a high level of audience engagement or the highest number of audience members in the room. For example, if three individuals are in the room when the media presentation begins and one person leaves, the entertainment client may wait until the third person returns to present the audience-aware ad pod.

In one embodiment, the primary content 1110 is divided into multiple phases or sections during which at least one advertisement pod must be displayed. When evaluating the best opportunity within a section, the current audience data may be compared against a threshold advertising return. If the first three of four insertion opportunities within the first section do not meet the threshold return, then the ad pod would be inserted into the fourth insertion point regardless of the calculated return. For example, an audience member could be displaying a low attention level for most of the first section, with occasional periods of medium attention. The initial threshold advertising return may only be possible when the audience member is paying full attention.

The threshold advertising return may be lowered for subsequent sections based on audience data gathered during the first section. For example, if the highest observed attention level was medium, then the threshold return may be reestablished based on the highest attention level or average attention level observed. In this example, the new threshold could be based on a medium attention level. Changing the threshold return maximizes the return by showing the ad pod at a point with the highest realistic return. The process may repeat for each period or section of the primary content 1110. If the audience attention level or response improves, then the threshold may go up.

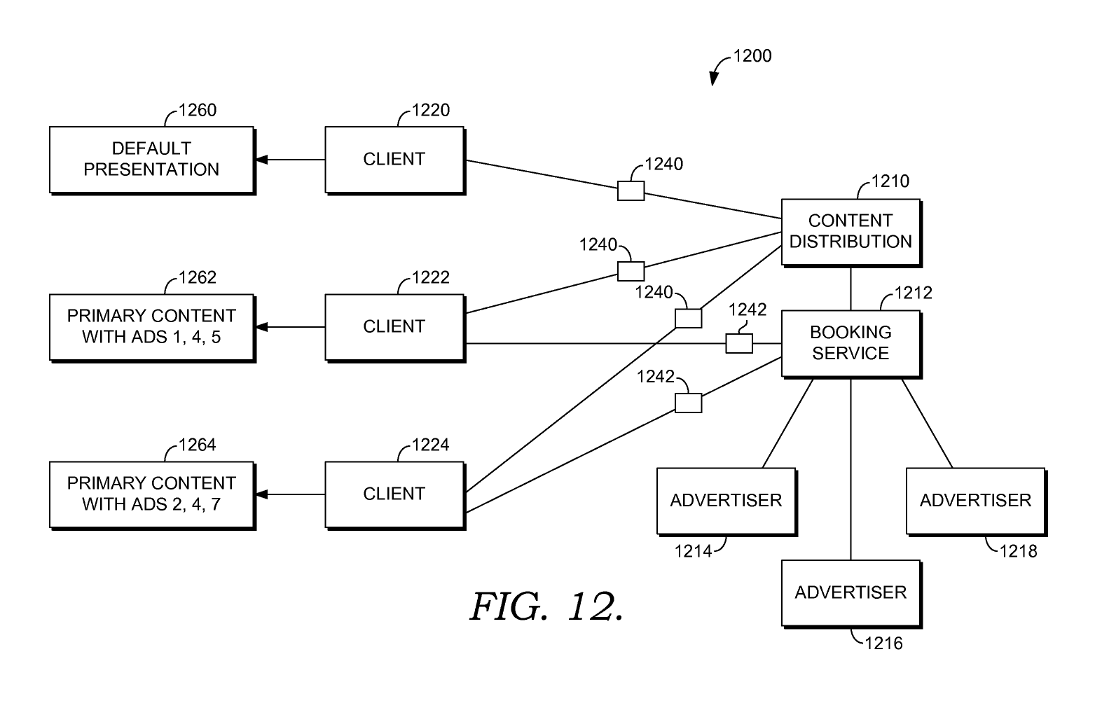

Turning now to FIG. 12, a remote advertising environment 1200 for generating audience-aware advertising is shown, in accordance with an embodiment of the present invention. The remote advertising environment 1200 includes a content distribution service 1210, an advertisement booking service 1212, advertiser 1214, advertiser 1216, and advertiser 1218. The booking service 1212 may run an auction that allows the advertisers to bid on the opportunity to present one of their advertisements to a specific audience. The audience may be determined on a screen-by-screen basis. For example, a first entertainment client may be displaying content to a single individual. The advertisers would be given the opportunity to bid on the opportunity to display an advertisement to that individual.

The actual individual(s) in the audience may remain anonymous to the advertiser. Instead, the advertisers may bid on the opportunity to display an advertisement to an audience member meeting designated criteria. Sets of criteria may be described as a persona. A persona is an abstraction of an individual. For example, advertiser 1214 may bid $2.00 for the opportunity to show its advertisement to a persona having the demographic criteria of being a woman and present in Seattle. The persona criteria may be much more granular and specify other detailed demographic characteristics, audience members' present level of attentiveness, and a reaction to content within a media presentation or other advertisements.

The booking service 1212 may communicate with the entertainment clients 1220, 1222, and 1224 to provide guidance on which advertisements should be displayed, for example within an audience-aware advertising pod. Each entertainment client receives image data depicting the audience for the media presentation. The media presentation 1240 may be received from the content distribution component 1210. In one example, the media presentation 1240 includes embedded advertising pods that have default advertisements. An entertainment client such as entertainment client 1220 that does not have audience-aware ad pod functionality will display the default ad pod within its default presentation 1260.

Entertainment clients 1222 and 1224 include audience-aware advertising functionality, in this example. The entertainment clients 1222 and 1224 receive a plurality of advertisements 1242 from the advertisement booking service 1212. The plurality of advertisements 1242 may each include target audience criteria that specifies how much an advertiser is willing to pay for display of its advertisement to a particular audience member based on the audience member's characteristics (persona). The entertainment client analyzes the audience data against the target audience criteria associated with each advertisement and selects an advertisement for display to the audience.

Each entertainment client may have a different audience and select a different group of ads to include in an ad pod. Entertainment client 1222 generates a media presentation 1262 including the primary content with ads 1, 4, and 5 included in an advertising pod. Entertainment client 1224 generates a media presentation 1264 including the primary content with ads 2, 4, and 7 inserted into an advertising pod.

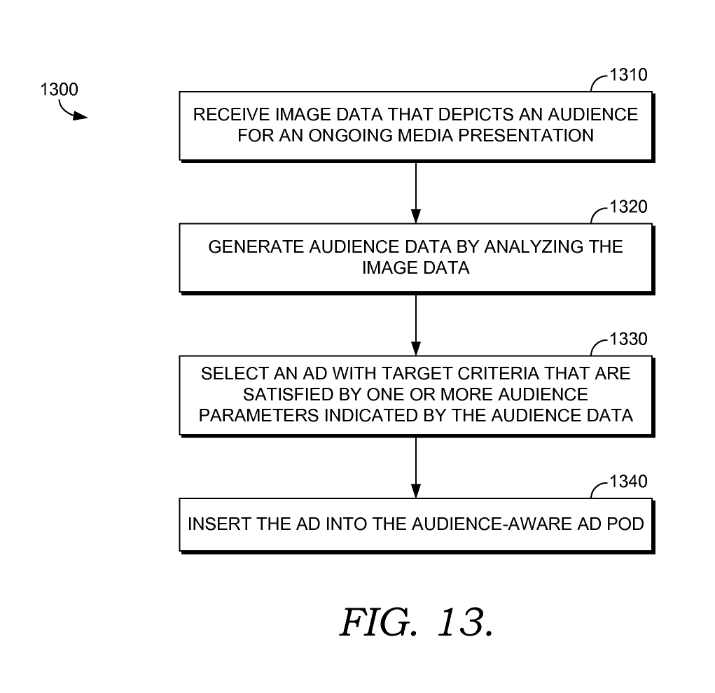

Turning now to FIG. 13, a method 1300 of selecting an advertisement for inclusion in an audience-aware ad pod is shown, in accordance with an embodiment of the present invention. The method may be performed on a game console or other entertainment device that is connected to an imaging device with a view of an audience area approximate to a display device.

At Step 1310, image data that depicts an audience for an ongoing media presentation is received. The image data may be in the form of a depth cloud generated by a depth camera, a video stream, still images, skeletal tracking information or other information derived from the image data. The ongoing media presentation may be a movie, game, television show, an advertisement, or the like. Ads shown during breaks in a television show may be considered part of the ongoing media presentation.

The audience may include one or more individuals within an audience area. The audience area includes the extents from which the ongoing media presentation may be viewed from the display device. The individuals within the audience area may be described as audience members herein.

At Step 1320, audience data is generated by analyzing the image data. Exemplary audience data has been described previously. The audience data may include a number of people that are present within the audience. For example, the audience data could indicate that five people are present within the audience area. The audience data may also associate audience members with demographic characteristics.

The audience data may also indicate an audience member's level of attentiveness to the ongoing media presentation. Different audience members may be associated with a different level of attentiveness. In one embodiment, the attentiveness is measured using distractions detected within the image data. In other words, a member's interactions with objects other than the display may be interpreted as the member paying less than full attention to the ongoing media presentation. For example, if the audience member is interacting with a different media presentation (e.g., reading a book, playing a game) then less than full attentiveness is paid to the ongoing media presentation. Interactions with other audience members may indicate a low level of attentiveness. Two audience members having a conversation may be assigned less than a full attentiveness level. Similarly, an individual speaking on a phone may be assigned less than full attention.

In addition to measuring distractions, an individual's actions in relation to the ongoing media presentation may be analyzed to determine a level of attentiveness. For example, the user's gaze may be analyzed to determine whether the audience member is looking at the display. When multiple content items are shown within the ongoing media presentation, such as an overlay over a primary content, gaze detection may be used to determine whether the user is ignoring the overlay and looking at the ongoing media presentation or is focused on the overlay, or even noticed the overlay for a short period. Thus, attentiveness information could be assigned to different content shown on a single display.

The audience data may also measure a user's reaction or response to the ongoing media presentation. As mentioned previously with reference to FIG. 6, a user's response or reaction may be measured based on biometric data and facial expressions.

At Step 1330, an ad is selected from a plurality of available advertisements because target audience criteria associated with the ad are satisfied by one or more audience parameters indicated by the audience data. For example, the audience parameters may indicate that a user is paying full attention to the media presentation and the target criteria specifies that the ad is only to be shown to a user paying full attention.

At Step 1340, the ad is inserted within the audience-aware ad pod. The audience-aware ad pod may include multiple advertisements that are selected based on the same criteria or through the same process. The audience-aware ad pod is shown or output for display to the audience in conjunction with the media presentation. The audience-aware ad pod may be displayed as an interruption to the media presentation or at the beginning or end of the media presentation. In one embodiment, the duration and location of the ad pod within the media presentation is designated within the media presentation received by the entertainment device. In another embodiment, the location of the ad pod is not specified. In one embodiment, the media presentation includes an ad pod that has one or more advertisements that must be shown and slots for other advertisements that may be selected and inserted.

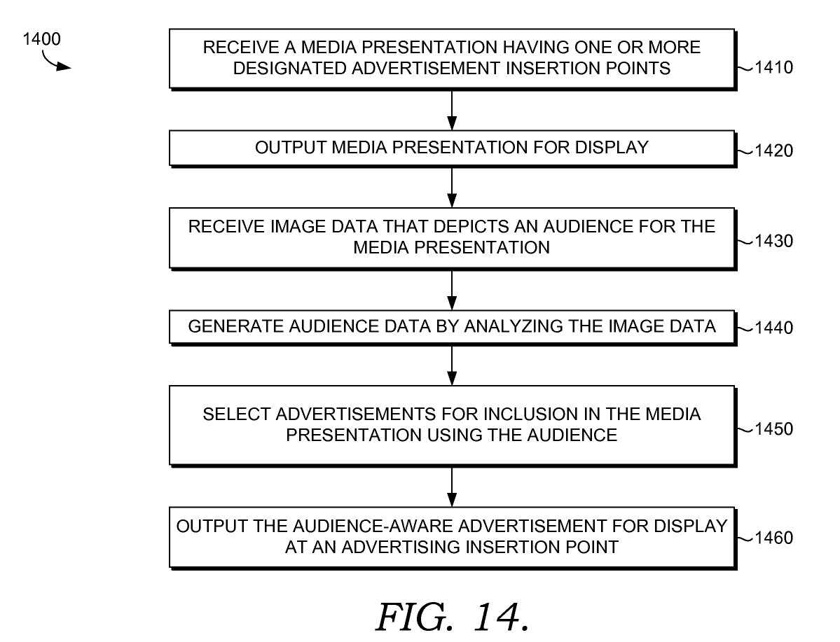

Turning now to FIG. 14, a method 1400 for generating an audience-aware advertising is shown, in accordance with an embodiment of the present invention. At Step 1410, a media presentation having one or more designated advertisement insertion points is received. The media presentation is received at an entertainment client, such as a game console, DVD player, Smart TV, tablet, or the like. The insertion point indicates a place where an audience-aware advertisement or audience-aware ad pod may be displayed, such as described previously with reference to FIG. 11. The insertion point could be a default ad pod or other ad pod that is embedded in the media presentation, such as those shown in FIGS. 7-10. The insertion point could be within a default ad pod where an default ad is replaced by an audience-aware ad.

At Step 1420, the media presentation is output for display. For example, the media presentation may be rendered and communicated to a television for display.

At Step 1430, image data depicting an audience for the media presentation is received. The image data may be in the form of a depth cloud generated by a depth camera, a video stream, still images, skeletal tracking information or other information derived from the image data. The ongoing media presentation may be a movie, game, television show, an advertisement, or the like. Ads shown during breaks in a television show may be considered part of the ongoing media presentation.

At Step 1440, audience data is generated by analyzing the image data. The audience data may include a number of people that are present within the audience. For example, the audience data could indicate that five people are present within the audience area. The audience data may also associate audience members with demographic characteristics. The audience data may include a viewer's attention level or response, as described above.

At Step 1450, an audience-aware ad is selected using the audience data to select an advertisement. The advertisement may be included in the audience-aware ad pod. As described previously, the audience data is used to match the current audience situation with target audience criteria specified by advertisers.

In a multiviewer audience, the advertiser may be charged different amounts for each person in the room. With a multiviewer audience, the advertisement with the overall highest return may be included in the ad pod. For example, an advertiser willing to pay $2.00 per view, regardless of demographic profile, to a room of six people would result in a $12.00 return. An advertiser that is willing to pay $4.00 to an individual within a demographic profile, but nothing for users not fitting that profile, would return only $8.00, if only two of the six audience members fit the profile.

The audience-aware advertising is output for display at an insertion point at Step 1460. In one embodiment, the advertising insertion point designates a duration for the advertisement. For example, the advertising insertion point may designate that an advertising pod of a two-minute duration may be displayed.

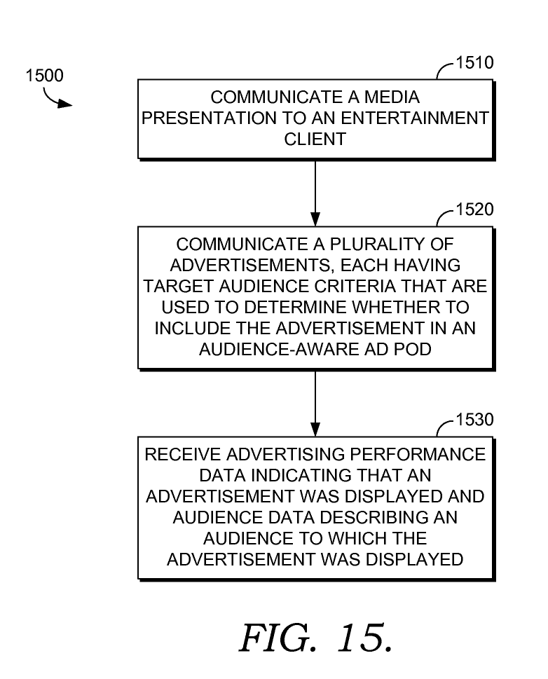

Turning now to FIG. 15, a method 1500 of generating an audience-aware advertising pod is shown, in accordance with an embodiment of the present invention. Method 1500 may be performed by an entertainment service that is remote from the entertainment client. The entertainment client and entertainment service or advertising service performing method 1500 may be communicatively coupled via a wide-area network, such as the Internet.

At Step 1510, a media presentation is communicated to an entertainment client. The communication may be a streaming event or a download where the entertainment device stores the presentation in long-term memory for subsequent presentation. At Step 1520, a plurality of advertisements, each having target audience criteria that are used to determine whether to include the advertisement in an audience-aware ad pod is communicated to the entertainment client. The plurality of advertisements may be communicated at any time including during presentation of media or when the entertainment client is on standby.

At Step 1530, advertising performance data is received by the entertainment client. The performance data indicates an advertisement was displayed and audience data describing an audience to which the advertisement was displayed. The advertisement could include a reaction or response to the displayed advertisement. The audience data indicates how many individuals were within the audience and various characteristics associated with those individuals.

In one embodiment, the audience data is received from the entertainment device. The audience data is used to select the advertisement for inclusion in the audience-aware ad pod based on an advertising auction that allows multiple advertisers to bid on an opportunity to advertise to one or more audience members described within the audience data. As mentioned, the advertisers may bid on a persona to which they want to advertise. When the persona matches the characteristics of an individual within the audience data, a match exists between the target audience criteria and the audience data. An instruction to display the advertisement is communicated to the entertainment client when a match is found. The advertising service may select the advertisement based on the highest expected return or other arrangements such as an obligation to include one or more designated advertisements within a media presentation.

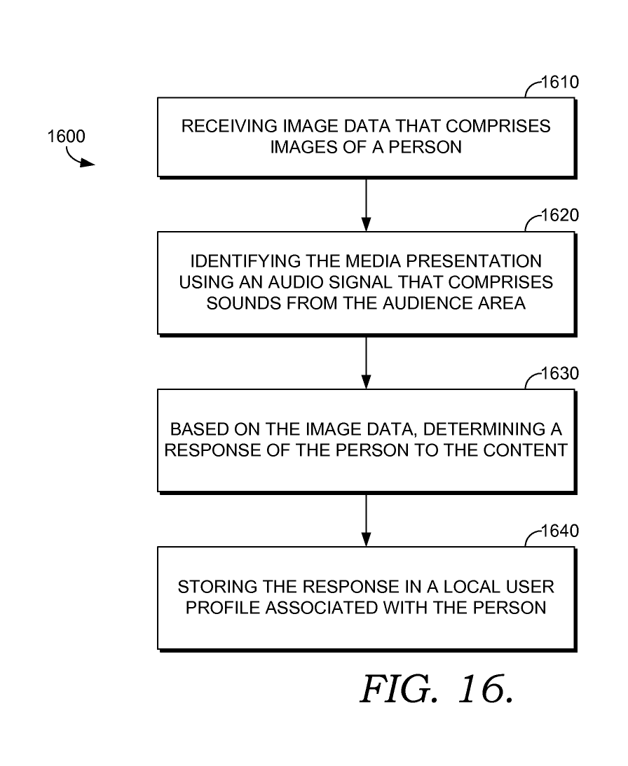

Turning to FIG. 16, a method 1600 for locally storing a person's response to a media title is described in accordance with an embodiment of the invention. At a step 1610, image data comprising images of the person is received. As described above, the image data may be received at an entertainment device, such as the entertainment device A 310 of FIG. 3, from an imaging device, such as a Web camera. The image data may depict the audience area where the person is located and that is proximate to a display device. The display device displays the content.

At a step 1620, a the media presentation is identified using an audio signal from the audience area. The media title may be identified because it is being run through the entertainment device. The media title may also be identified by using automatic content recognition techniques, as described above. In this way, audio output from speakers associated with the display device will be compared to a database of known media content, such as the content recognition database 342 of FIG. 3, and a source of the audio output will be identified and returned. The audio output may be recorded by a microphone associated with the entertainment device. Identifying media content may include identifying a title of the media content (e.g., the name of a movie), identifying a provider, director, producer or publisher of the content, identifying a genre to which the content belongs (e.g., sports, movies, games, etc.), a combination thereof, and the like.

At a step 1630, the images are utilized to determine a response of the person toward the media title. The response may be determined based on a change in facial expression, a change in a biometric reading of the first person, a movement of the person, a change in the direction the person is facing, and the like. For example, the images may include the person frowning, smiling, laughing, glaring, yelling, and/or falling asleep. Similarly, a response might include the person getting up and walking out of the audience area. Any such responses and countless other responses are capable of being distilled from the image data. The response may further be mapped to a level of engagement of the person toward the content, a distraction associated with the level of engagement, or an emotion of the person.

At a step 1640, the responses and/or mapped levels of engagement or emotion may be stored in a local file, such as a user profile, associated with the person. In addition to the response or engagement information, the information may include a name of the media content, a genre related to the media content, a designation of whether the content is primary or secondary content, a provider of the content, a year the content was published, names or titles of related content materials (e.g., sequels), and the like. The information may also include demographic information such as the user's approximate age or gender. The demographic information may be determined using image data, user account information, or though other sources. It will be understood that the information that identifies the content may be numerous and comprehensive. The examples provided herein are merely exemplary.

Storing the user profile locally may enhance user privacy by eliminating a need to communicate the profile data to an advertiser or ad network. The user profile may be analyzed locally to surface only generalized viewing information that is exposed to the advertiser, content provider, or others. In one embodiment, the viewing information is abstracted to a level that prevents identification of the viewer. The user profile information may be encrypted to prevent direct access by an advertiser or other party. In one embodiment, the user is invited to supply a pass code used to form the encryption key. Data in the encrypted user profile may be accessed by a program on the client that analyzes the user profile to classify the viewing record into generalized characteristics or categories of interest to an advertiser. The general characteristics or categories may be exposed to advertisers, content providers, and the like, but the actual viewing record with detailed information remains protected. The general characteristics or categories may be standardized across clients to enable use by advertisers or others that subscribe to consume locally stored information. Storing the user profile locally also conserves network data usage.

Although not shown, other steps in this method 1600 may be possible. For example, a determination may be made that the person has selected specific media content. Selection of media content may be initiated by loading content on the entertainment device. For example, inserting a video game into the entertainment device qualifies as “selecting” content. The user selection may similarly be initiated by using a remote control or other device to press, click, or tap a button or icon that selects content. More weight may be given to selected content than to browsed content when determining a user's interests within a profile.

A determination about a response of the person to the title or content being displayed may be made. The response may include a change to a facial expression, a change in a biometric reading of the first person, a movement of the person, a change to the direction the person is facing, and the like. The response may further be mapped to a level of engagement or an emotion. All such processed information about the person may be locally stored in the user profile associated with the person.

In one embodiment, a persona may be assigned to the person. The persona is an abstraction that describes a preference, interest or like or dislike of the person. The persona may be assigned based on the person's response to media content or the person's determined level of engagement or emotion toward the media content. For example, when the person is very engaged in a commercial for a hair care product, the user may be assigned a persona that indicates the user “likes hair care products,” “likes health and beauty advertisements,” or the like. A persona may also be assigned to the person based on the person's determined personal characteristics or viewing selections. Over time, the person's assigned personas may change or be updated. A person may be assigned multiple personas. The personas may be stored in the local file/user profile associated with the person.

A determination may be made that multiple persons are viewing media content. Responses of each of the persons toward the media may be determined. If each person's responses are mapped to a same emotion or a same level of engagement, a group persona may be assigned to the group of persons. The group persona may be stored in a group profile associated with the persons and locally stored as a group user profile or file on the game console. If the responses of each person in the group are not the same, then only individual personas reflecting the individual person's responses or emotions/levels of engagement will be stored.

In some embodiments, the stored persona acts as a cookie. The persona may be communicated to a server that exposes the persona to an advertiser. In response, the advertiser may select targeted content to display to a persona and communicate such targeted content to an entertainment service, such as the entertainment service 330. The entertainment service may then receive real-time information indicating that the person to whom the persona was assigned is viewing content on the display device. Additionally, the entertainment service may receive information that the entertainment device is feeding content to the display device while the person is viewing the display device. The entertainment service may then communicate the targeted content to the entertainment device while the person is viewing the display. The entertainment device may then, in real-time, display the targeted media content to the person, according to an advertisement placement protocol, as described above.

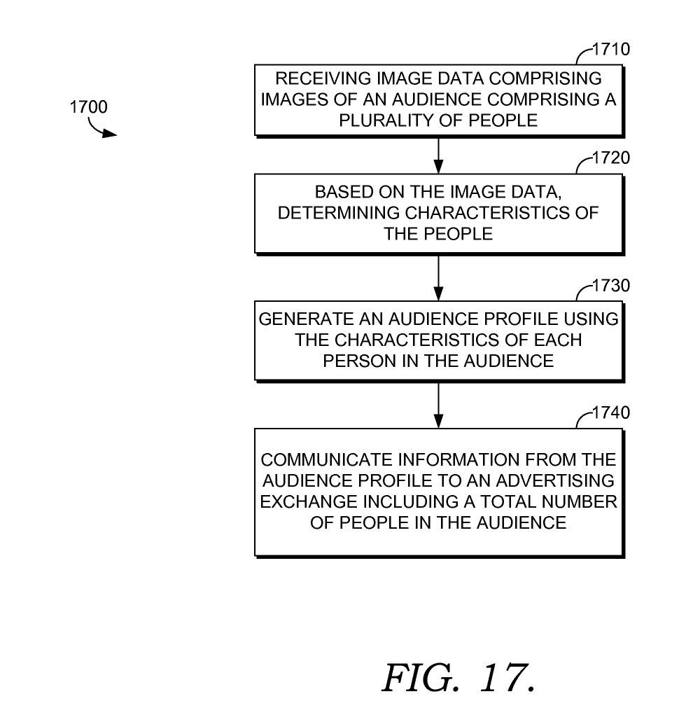

Turning to FIG. 17, a method 1700 for method for generating an audience profile is described, in accordance with an embodiment of the invention. At a step 1710, image data comprising images of an audience comprising multiple people is received. The image data may be received from an imaging device, such as a depth camera that is associated with an entertainment device (e.g., entertainment device A 310 of FIG. 3) and located near to a display device. The display device may be a television or other device that displays media content. The images captured at the imaging device may depict a portion of the display device's audience area. The audience area is an area proximate to the display device where the person can see displayed content or hear audio output from the display device. The person within the audience area may be detected because of his or her form, size, appendages, height, weight, facial features, biometric readings, and the like.

At a step 1720, characteristics of people in the audience are determined. The characteristics may be determined based on image processing. Such processing may lead to a determination of, for example, the person's gender, age, physical capabilities or disabilities, identity (based on facial recognition processing), facial features, weight, height, and the like. Such characteristics may be numerous or limited. Additionally, a user's present attention level or emotional state may be determined.

At a step 1730, an audience profile is generated using the characteristics determined at Step 1720. The audience profile may have already been created and is only updated during the step 1730. Information stored in the profile may include, for example, personal information such as a name, address, gender, age, account information, and the like. The audience profile may also include characteristics of the people it is associated with, in addition to the people's responses to and viewing histories/selections of media content. The audience profile also may be associated with more than one person (i.e., a group user profile). In such a case, the characteristics of each audience member may be mapped to both a group audience profile and an individual user profile. In one embodiment, the characteristics of the person are only mapped to the group user profile, if other members in the group are also present with the person. As well, the individual profile may be associated with an account for the person. In this way, the person may be associated with a user profile because he or she has inputted login credentials associated with her account/profile.

The audience profile may list the amount of people in the audience along with characteristics of each audience member. In one embodiment, the audience profile describes the entire group. For example, the audience profile may indicate the audience is a family with young kids, family with teen agers, mixed gender group of young adults, group of women, etc.

The audience profile may be used to select advertisements based on the group as a whole or by its constituent members. For example, the advertiser may specify a desire to show an advertisement to a family with kids and bid on the opportunity as a group. Alternatively, the advertiser may specify and bid different amounts for each group member. The advertiser with the highest total bid when the individual bids for each audience member is totaled would win advertising auction.

If a stored user profile does not have stored characteristics for a person that match those of the person depicted in the image data, a new user profile for the person may be created. The new user profile may include the newly-detected characteristics of the person, in addition to other information, such as, for example, content viewed, content selected, responses to content, interest levels in content, and the like. The person may also be prompted to input new personal information about him or herself when a new profile is being created. As well, the person may be given an option to select a profile that is associated with him or her.

At Step 1740, information from the audience profile is communicated to an advertising exchange. The information describes a total number of people in the audience. The information may be communicated by granting the advertiser or advertising exchange access to a local file stored on the entertainment device. The audience profile could be communicated to the ad exchange. The information may be a series of individual personas or a group persona. The information may be used to bid in real-time for the opportunity to advertise to the audience.

Embodiments of the invention have been described to be illustrative rather than restrictive. It will be understood that certain features and subcombinations are of utility and may be employed without reference to other features and subcombinations. This is contemplated by and is within the scope of the claims.

1-8. (canceled)

9. A method of audience-aware advertising comprising:
receiving, at an entertainment client, a media presentation having one or more designated advertisement insertion points;
outputting the media presentation for display;
receiving image data that depicts an audience for the media presentation;
generating audience data by analyzing the image data;
selecting an advertisement for insertion into the media presentation using the audience data, wherein a duration of the advertisement is variable in length;
outputting the advertisement for display at an advertising insertion point; and
determining the duration of the advertisement based on an audience response to the advertisement, the audience response determined from new image data received concurrently with said outputting the advertisement for display.

10. The method of claim 9, wherein the advertising insertion point designates a duration for the advertisement or a series of advertisement within an ad pod.

11. The method of claim 9, further comprising:
receiving a default advertising ad pod having one or more default advertisements for display; and
generating an audience-aware ad pod by replacing all of the one or more default advertisements with targeted advertisements that are associated with target audience criteria that matches parameters indicated by the audience data.

12. The method of claim 9, further comprising:
receiving a default advertising ad pod having two or more default advertisements for display; and
generating an audience-aware ad pod by replacing less than all of the two or more default advertisements with targeted advertisements that are associated with target audience criteria that matches parameters indicated by the audience data.

13. The method of claim 12, wherein the audience data comprises an audience member's response to a preliminary advertisement shown during the media presentation and target audience criteria indicate a subsequent advertisement should only be shown when the response is positive.

14. (canceled)

15. The method of claim 9, further comprising:
analyzing audience data during presentation of the advertisement to determine whether the advertisement should be terminated at an early end point or continue to a subsequent end point.

16. The method of claim 9, further comprising:
calculating an advertiser's bid for insertion of an ad into the media presentation by summing bids for individual audience members identified in the audience data.

17-20. (canceled)

21. A method of audience-aware advertising comprising:
receiving, at an entertainment client, a media presentation having one or more designated advertisement insertion points;
outputting the media presentation for display;
receiving image data that depicts an audience for the media presentation;
generating audience data by analyzing the image data;
selecting an advertisement for insertion into the media presentation using the audience data;
outputting the advertisement for display at an advertising insertion point;
determining that the advertisement should be terminated at an early end point rather than continue to a subsequent end point by the analyzing new audience data generated during said outputting the advertisement for display; and
terminating said outputting the advertisement at the early end point.

22. The method of claim 21, wherein the advertising insertion point designates a duration for the advertisement or a series of advertisement within an ad pod.

23. The method of claim 21, further comprising:
receiving a default advertising ad pod having one or more default advertisements for display; and
generating an audience-aware ad pod by replacing all of the one or more default advertisements with targeted advertisements that are associated with target audience criteria that matches parameters indicated by the audience data.

24. The method of claim 23, wherein the audience data comprises an audience member's response to a preliminary advertisement shown during the media presentation and target audience criteria indicate a subsequent advertisement should only be shown when the response is positive.

25. The method of claim 21, further comprising:
receiving a default advertising ad pod having two or more default advertisements for display; and
generating an audience-aware ad pod by replacing less than all of the two or more default advertisements with targeted advertisements that are associated with target audience criteria that matches parameters indicated by the audience data.

26. The method of claim 21, further comprising:
calculating an advertiser's bid for insertion of an ad into the media presentation by summing bids for individual audience members identified in the audience data.

27. One or more computer-storage media having computer executable instructions embodied thereon, that when executed by a computing device perform a method of audience-aware advertising, the method comprising:
receiving, at an entertainment client, a media presentation having one or more designated advertisement insertion points;
outputting the media presentation for display;
receiving image data that depicts an audience for the media presentation;
generating audience data by analyzing the image data;
selecting an advertisement for insertion into the media presentation using the audience data, wherein a duration of the advertisement is variable in length;
outputting the advertisement for display at an advertising insertion point; and
determining the duration of the advertisement based on an audience response to the advertisement, the audience response determined from new image data received concurrently with said outputting the advertisement for display.

28. The media of claim 27, wherein the advertising insertion point designates a duration for the advertisement or a series of advertisement within an ad pod.

29. The media of claim 27, further comprising:
receiving a default advertising ad pod having one or more default advertisements for display; and
generating an audience-aware ad pod by replacing all of the one or more default advertisements with targeted advertisements that are associated with target audience criteria that matches parameters indicated by the audience data.

30. The media of claim 27, further comprising:
receiving a default advertising ad pod having two or more default advertisements for display; and
generating an audience-aware ad pod by replacing less than all of the two or more default advertisements with targeted advertisements that are associated with target audience criteria that matches parameters indicated by the audience data.

31. The media of claim 30, wherein the audience data comprises an audience member's response to a preliminary advertisement shown during the media presentation and target audience criteria indicate a subsequent advertisement should only be shown when the response is positive.

32. The media of claim 27, further comprising:
analyzing audience data during presentation of the advertisement to determine whether the advertisement should be terminated at an early end point or continue to a subsequent end point.

33. The media of claim 27, further comprising:
calculating an advertiser's bid for insertion of an ad into the media presentation by summing bids for individual audience members identified in the audience data.
